(19) United States
(12) Patent Application Publication
(10) Pub. No.: US 2011/0174790 A1
(43) Pub. Date: Jul. 21, 2011

(54) ANNEALING APPARATUS

(75) Inventors: Tomohiro Suzuki, Yamanashi-ken (JP); Masatake Yoneda, Yamanashi-ken (JP); Shigeru Kasai, Yamanashi-ken (JP); Kazuhiro Ooya, Yamanashi-ken (JP)

(73) Assignee: TOKYO ELECTRON LIMITED, Tokyo-To (JP)

(21) Appl. No.: 13/001,357

(22) PCT Filed: Jun. 24, 2009
(86) PCT No.: PCT/JP2009/061518

§ 371 Date: Mar. 30, 2011

(30) Foreign Application Priority Data
Jun. 25, 2008 (JP) 2008-165733
Nov. 28, 2008 (JP) 2008-304468
Dec. 4, 2008 (JP) 2008-310112

(51) Int. Cl. B23K 26/12; B23K 26/00

(52) U.S. Cl. 219/121.84; 219/121.86

(57) ABSTRACT

The present invention is an annealing apparatus configured to perform an annealing process to an object to be processed, the annealing apparatus comprising: a processing vessel in which the object to be processed can be accommodated; a support unit configured to support the object to be processed in the processing vessel; a gas supply unit configured to supply a process gas into the processing vessel; an exhaust unit configured to discharge an atmosphere in the processing vessel; and a rear-side heating unit including a plurality of laser elements configured to irradiate heating light beams toward an overall rear surface of the object to be processed.

### FIELD OF THE INVENTION

The present invention relates to an annealing apparatus configured to perform an annealing process to an object to be processed such as a semiconductor wafer. In particular, the present invention relates to an annealing apparatus configured to perform an annealing process by irradiating heating light beams from laser elements or LED (Light Emitting Diode) elements.

### BACKGROUND ART

Generally, in order to manufacture a semiconductor integrated circuit, a semiconductor wafer such as a silicon substrate is repeatedly subjected to various processes such as a film deposition process, an oxidation and diffusion process, a modification process, an etching process, an annealing process, and so on. In an annealing process for activating impurity atoms which have been doped in the wafer after an ion plantation, the temperature of the semiconductor wafer should be promptly increased and decreased in order to restrain diffusion of the impurities to the minimum.

A conventional annealing apparatus heats a wafer by using a halogen lamp and so on. However, it takes at least about one second for the halogen lamp, after lighting thereof, to become stable as a heating source. Thus, there is recently proposed an annealing process in which LED elements are used as a heating source (JP2005-536045T). As compared with the halogen lamp, the LED element is excellent in switching response, and is capable of more promptly increasing and decreasing a temperature thereof.

There is further proposed a technique in which laser elements are used as another heating source, and a wafer is heated by heating light beams generated from the laser elements, while the heating light beams being scanned on the surface of the wafer (for example, JP2005-244191A).

As described above, when the LED elements or the laser elements are used as a heating source, it is advantageous in that a prompt temperature increasing/decreasing operation to a wafer is relatively possible. Further, in the case of the LED elements, since the wavelength of the heating light beam has a certain degree of width, it is advantageous in that a wafer can be heated with an in-plane uniformity, independently of a surface condition of the wafer W.

However, when the LED element is used, a light emitting efficiency thereof is about 10 to 30%, which is considerably lower than a light emitting efficiency of about 40 to 50% of the laser element. Namely, the LED element is disadvantageous in that an energy efficiency thereof is low, as compared with the laser element.

On the other hand, as described above, the laser element is more excellent in the light emitting efficiency than the LED element. However, since the heating light beam is a monochromatic light beam (the heating light beam has a single wavelength), there may occur a problem in that a temperature distribution is biased (becomes non-uniform), depending on a structure of the surface of a wafer to be heated and/or a surface condition thereof. For example, when the wafer surface has an amorphous portion, a metal portion or an insulation film portion, these portions have different absorption wavelengths of light (different absorptances with respect to a specific wavelength) depending on materials of the portions. Thus, when laser beams (heating light beams), which are monochromatic light beams, are irradiated onto these portions, the temperature distribution on the wafer surface becomes non-uniform, because of the differences in the absorptances of the materials corresponding to the wavelength.

### SUMMARY OF THE INVENTION

In view of the above problems, the present invention has been made in order to effectively solve the same. The object of the present invention is to provide an annealing apparatus capable of heating an object to be processed for a short period of time with a uniform in-plane temperature, and of achieving a high energy conversion efficiency while saving energy.

The present invention is an annealing apparatus configured to perform an annealing process to an object to be processed, the annealing apparatus comprising: a processing vessel in which the object to be processed can be accommodated; a support unit configured to support the object to be processed in the processing vessel; a gas supply unit configured to supply a process gas into the processing vessel; an exhaust unit configured to discharge an atmosphere in the processing vessel; and a rear-side heating unit including a plurality of laser elements configured to irradiate heating light beams toward an overall rear surface of the object to be processed.

According to the present invention, laser beams are irradiated as heating light beam onto the object to be processed from a rear surface thereof whose condition is uniform. Thus, the object to be processed can be heated for a short period of time with a uniform in-plane temperature. In addition, higher energy conversion efficiency of the laser elements can contribute to energy saving.

Preferably, the plurality of laser elements are arranged over a range that is large enough to cover at least the overall rear surface of the object to be processed.

In addition, for example, each laser element is formed of a semiconductor laser element, a solid element, or a gas laser element.

In addition, preferably, the heating light beam irradiated from each laser element has a wavelength band capable of selectively heat a silicon substrate.

In addition, preferably, one of the support unit and the rear-side heating unit is rotatably supported.

In addition, preferably, there is further provided a front-side heating unit arranged opposedly to the rear-side heating unit, the front-side heating unit being configured to irradiate heating light beams toward a front surface of the object to be processed.

In this case, preferably, the front-side heating unit includes a plurality of LED (Light Emitting Diode) elements or SLD (Super Luminescent Diode) elements which are arranged over a range that is large enough to cover at least the overall front surface of the object to be processed.

When the LED elements or the SLD elements are used as the front-side heating unit, heating light beams having a wide light emitting wavelength width can be irradiated onto the object to be processed from a front surface thereof. Thus, independently of the surface condition of the object to be processed, the object to be processed can be heated for a more short period of time with a uniform in-plane temperature.

In addition, preferably, at least one of the rear-side heating unit and the front-side heating unit is provided with a cooling mechanism configured to perform a cooling by a coolant.

In this case, preferably, he cooling mechanism includes a coolant passage through which the coolant flows, and

the coolant passage is set such that superficial dimension of flow path of the coolant passage is sequentially reduced from a coolant inlet toward a coolant outlet.

In this manner, by setting the superficial dimension of the flow path of the coolant passage such that the superficial dimension is sequentially reduced from the coolant inlet to the coolant outlet, heat values per unit length of the coolant passage that are to be drawn by the coolant from the objects to be cooled can be made constant. As a result, it is possible to make uniform the temperatures of the objects to be cooled along the longitudinal direction of the coolant passage.

In this case, preferably, a width of the coolant passage is constant, and a height of the coolant passage is determined based on a flow rate of the coolant, a specific heat of the coolant, a density of the coolant, and a distance from the coolant inlet. Moreover, in this case, preferably the height f(x) of the coolant passage is given by the following expression:

f(x)=A²·(To−T(x))²/(Q·cp²·ρ²·(T′(x))²) wherein

A: constant for obtaining heat transfer rate;
Q: flow rate of coolant;
cp: specific heat of coolant;
ρ: density of coolant;
x: distance from coolant inlet;
T(x): coolant temperature at a position of distance x (function)
T′(x): derivative of function T(x); and
To: target temperature.

In addition, preferably, the cooling mechanism is provided with a plurality of heat pipes for promoting the cooling.

In addition, preferably, a reflection surface is formed on the rear-side heating unit.

### BRIEF DESCRIPTION OF THE DRAWINGS

FIG. 1 is a sectional view showing a schematic structure of an annealing apparatus in one embodiment according to the present invention;

FIG. 2A is a plan view showing a surface (lower surface) of a front-side heating unit;

FIG. 2B is an enlarged plan view of a portion (one LED module) of the surface (lower surface) of the front-side heating unit;

FIG. 3 is an enlarged sectional view showing a part A in FIG. 1 which is a portion of the front-side heating unit;

FIG. 4 is a plan view showing a surface (upper surface) of a rear-side heating unit;

FIG. 5 is an explanatory view for explaining a light emitting condition of semiconductor laser elements;

FIG. 6 is a schematic view showing an irradiation condition of laser beams (heating light beams) from the laser elements;

FIG. 7 is an enlarged perspective view showing one of coolant passages in an upper cooling mechanism of an element attachment head;

FIG. 8 is a partial structural view showing a lower part of a processing vessel including a support unit, in the annealing apparatus in an alternative embodiment according to the present invention;

FIG. 9 is a schematic view for obtaining a temperature variation of a coolant in a minute section in a longitudinal direction of the coolant passage;

FIG. 10 is a graph showing a height function f(x) of the coolant passage;

FIG. 11 is a view showing an example of a change in heights of sectional shapes of the coolant passage;

FIG. 12 is a plan view showing an arrangement of laser units and semiconductor laser elements of the heating unit;

FIG. 13 is a graph showing a distribution of heating light beams (light outputs) outputted from the heating unit shown in FIG. 12;

FIG. 14 is an enlarged perspective view showing a laser unit;

FIGS. 15A and 15B are graphs each showing an expansion of light spots outputted from the semiconductor laser elements;

FIG. 16 is a plan view showing an example of another embodiment of an arrangement of the laser units of the heating unit;

FIG. 17 is a graph showing a distribution of heating light beams (light outputs) outputted from the heating unit shown in FIG. 16; and

FIG. 18 is an enlarged perspective view showing an example of an alternative embodiment of the laser unit.

### BEST MODE FOR CARRYING OUT THE INVENTION

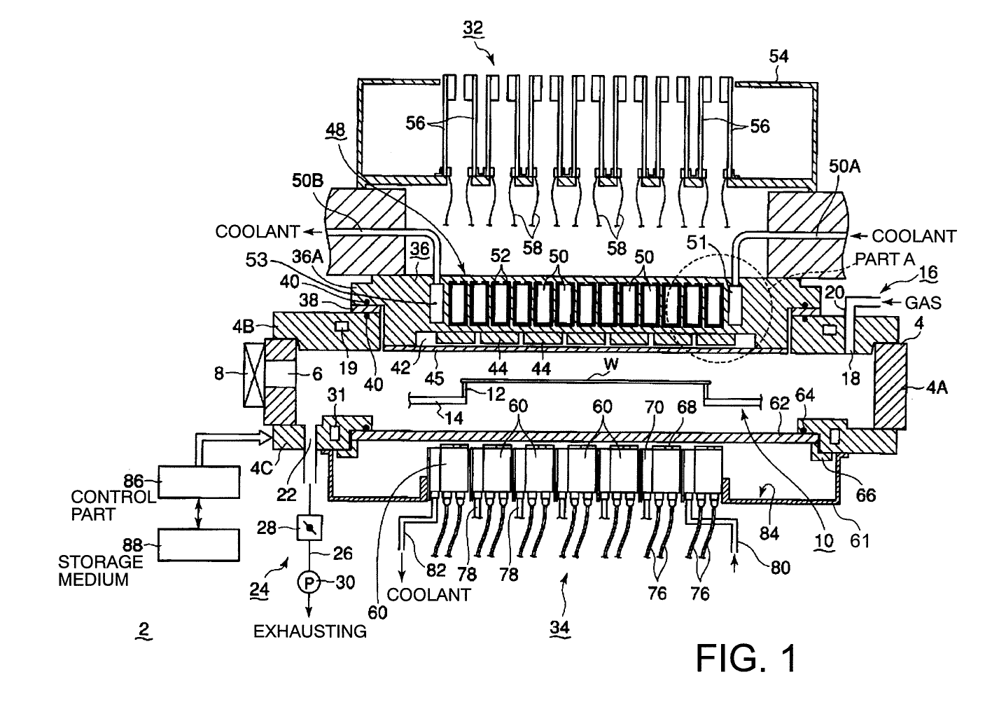

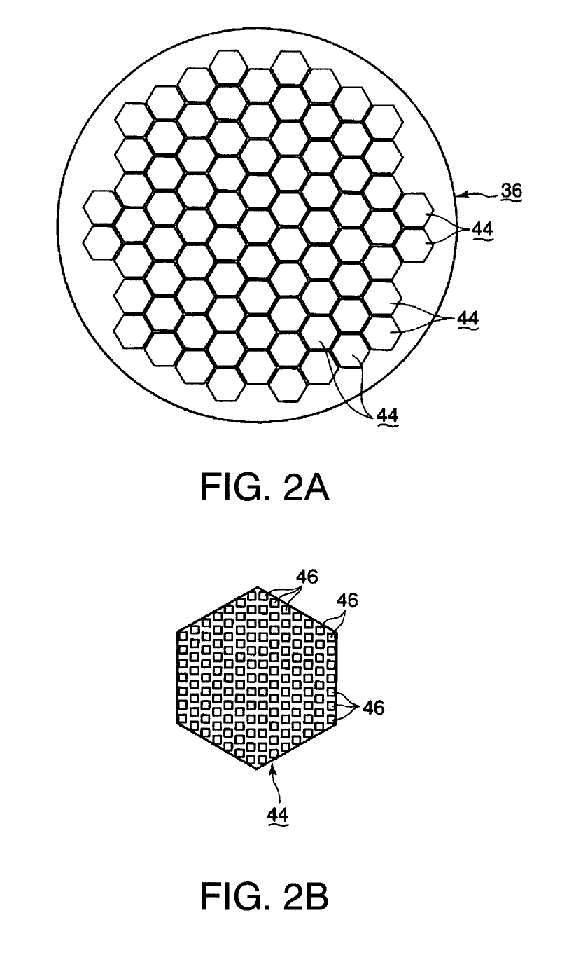

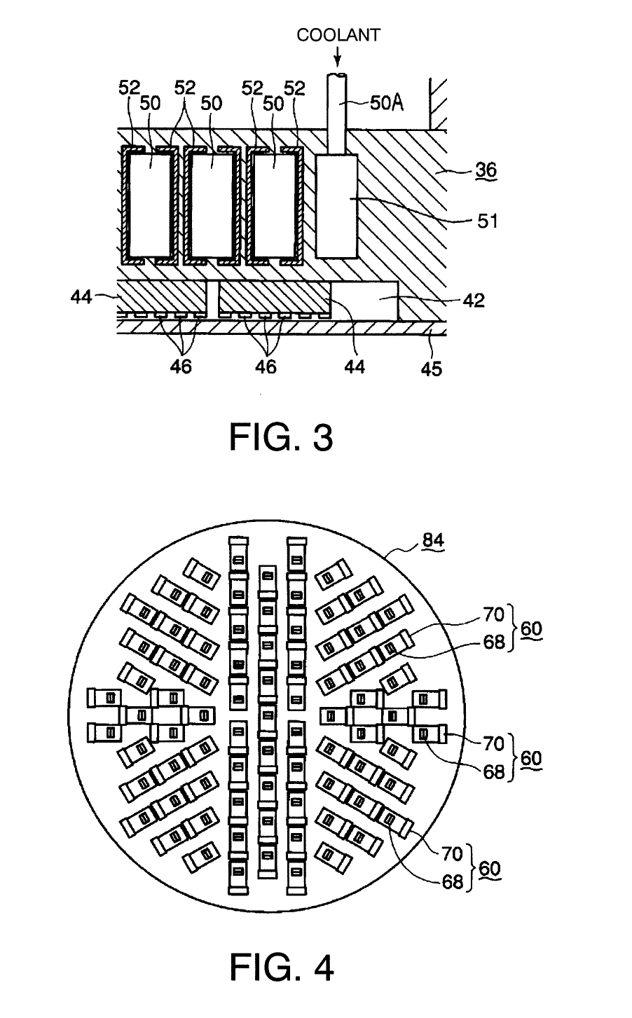

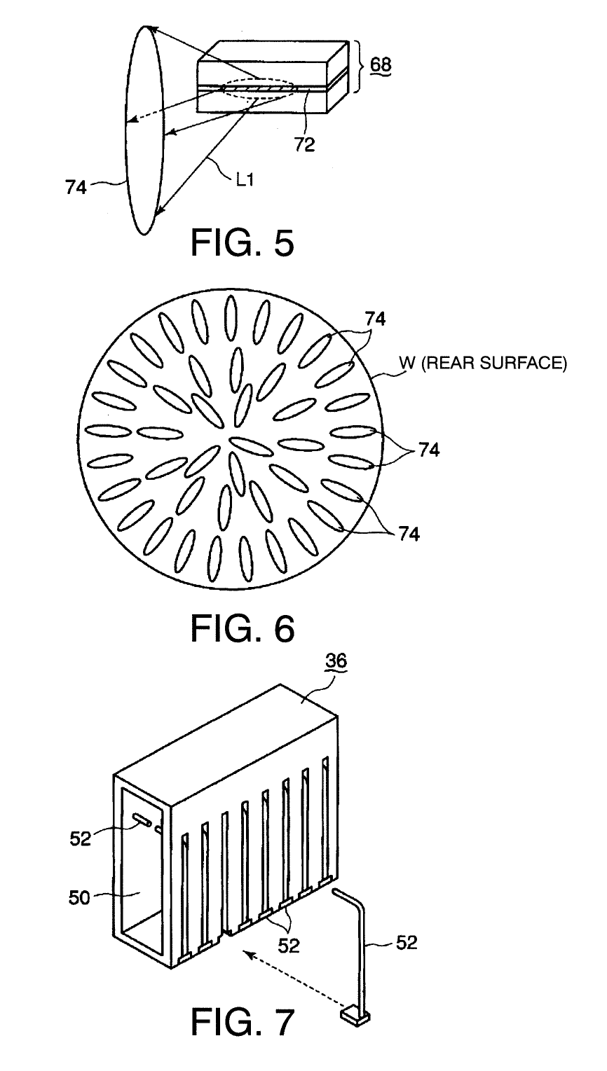

An embodiment of an annealing apparatus according to the present invention will be described herebelow with reference to the attached drawings. FIG. 1 is a sectional view showing a schematic structure of the annealing apparatus in one embodiment according to the present invention. FIG. 2A is a plan view showing a surface (lower surface) of a front-side heating unit. FIG. 2B is an enlarged view of a portion of the surface (lower surface) of the front-side heating unit. FIG. 3 is an enlarged sectional view showing a part A in FIG. 1 which is a portion of the front-side heating unit. FIG. 4 is a plan view showing a surface (upper surface) of a rear-side heating unit. FIG. 5 is an explanatory view for explaining a light emitting condition of semiconductor laser elements. FIG. 6 is a schematic view showing an irradiation condition of laser beams (heating light beams) from the laser elements. Herein, a semiconductor wafer formed of a silicon substrate is used as an object to be processed. Given herein as an example to describe the present invention is a case in which the wafer is annealed, with impurities having been injected to a surface of the wafer.

As shown in FIG. 1, an annealing apparatus 2 in this embodiment includes a hollow processing vessel 4 made of aluminium or aluminum alloy. The processing vessel 4 is composed of a cylindrical side wall 4A, a ceiling plate 4B joined to an upper end of the side wall 4A; and a bottom plate 4C joined to a bottom part of the side wall 4A. The side wall 4A has a loading/unloading port 6 which is sized such that a semiconductor wafer W as an object to be processed can be loaded and unloaded through the loading/unloading port 6. An openable and closable gate valve 8 is disposed on the loading/unloading port 6.

In the processing vessel 4, there is provided a support unit 10 configured to support the wafer W. The support unit 10 has a plurality of, e.g., three support pins 12 (only two support pins 12 are shown in FIG. 1), and elevating arms 14 connected to lower ends of the respective support pins 12. The respective elevating arms 14 can be elevated and lowered (moved upward and downward) by an actuator, not shown, so that the elevating arms 14 together with the support pins 12 can be elevated and lowered, with the wafer W being supported on upper ends of the support pins 12.

A gas supply unit 16 is formed on a portion of a peripheral part of the ceiling plate 4B. The gas supply unit 16 is composed of a gas inlet 18 formed in the ceiling plate 4B, and a gas pipe 20 connected to the gas inlet 18. A required process gas can be introduced into the processing vessel 4, while a flow rate of the gas being controlled by a flow-rate controller, not shown. Herein, N₂ gas or a rare gas such as Ar or He can be used as a process gas. Formed in the ceiling plate 4B is an upper-side coolant passage 19 through which a coolant for cooling the ceiling plate 4B flows.

In addition, a gas outlet 22 is formed in a portion of a peripheral part of the bottom plate 4C. The gas outlet 22 is provided with an exhaust unit 24 configured to discharge an atmosphere in the processing vessel 4. The exhaust unit 24 has a gas exhaust pipe 26 connected to the gas outlet 22. A pressure adjusting valve 28 and an exhaust pump 30 are disposed on the gas exhaust pipe 26. In addition, formed in the bottom plate 4C is a lower-side coolant passage 31 through which a coolant for cooling the bottom plate 4C flows.

An opening of a large diameter is formed in the center of the ceiling plate 4B. A front-side heating unit 32 is fitted in the opening, whereby a front surface (upper surface) of the wafer W can be heated. In addition, an opening of a large diameter is also formed in the center of the bottom plate 4C. A rear-side heating unit 34, which is the feature of the present invention, is fitted in the opening so as to be opposed to the front-side heating unit 32, whereby a rear surface (lower surface) of the wafer W can be heated. Herein, the front surface of the wafer W is a surface which is subjected to various processes such as a film deposition process and an etching process, so that a device is formed thereon. On the other hand, the rear surface of the wafer W is a surface opposite to the front surface of the wafer W, on which no device is formed. When a heating amount of the rear-side heating unit 34 is sufficiently large, provision of the front-side heating unit 32 may be omitted.

<Description of Front-Side Heating Unit>

Next, the front-side heating unit 32 is described. The front-side heating unit 32 is provided with an element attachment head 36 that is fitted in the opening of the ceiling plate 4B with a slight gap therebetween. The element attachment head 36 is made of a highly heat conductive material such as aluminum or aluminum alloy. The element attachment head 36 has a circular ring-shaped attachment flange 36A formed on an upper part thereof. The element attachment head 36 is supported by the ceiling plate 4B at the portion of the attachment flange 36A, with a heat insulation member 38 made of, e.g., polyether imide being interposed between the attachment flange 36A and the ceiling plate 4B.

Sealing members 40 such as O-rings are provided on upper and lower sides of the heat insulation member 38, so as to maintain a hermetically sealing state of this portion. Formed on a lower surface of the element attachment head 36 is an element attachment recess 42 whose diameter is slightly larger than the diameter of the wafer W. A plurality of LED modules 44 are disposed on a plane (flat) portion of the element attachment recess 42 over a range that is large enough to cover at least an overall front surface of the wafer W. A light transmitting plate 45 formed of, e.g., a quartz plate, is attached to an opened portion of the element attachment recess 42.

As shown in FIG. 2A, each LED module 44 has a regular hexagonal shape one side of which is about 25 mm. The LED modules 44 are arranged closely or densely, such that the adjacent sides are substantially in contact with each other. When the diameter of the wafer W is 300 mm, the number of the LED modules 44 is about eighty, for example. FIG. 2B is an enlarged plan view showing one LED module. As shown in FIGS. 2B and 3, each LED module 44 is constituted by arranging on a surface thereof a number of LED elements 46 longitudinally and laterally. In this case, the dimensions of each LED element 46 are about 0.5 mm×0.5 mm. About 1000 to 2000 LED elements 46 are mounted on each LED module 44. The LED elements 46 are separated into a plurality of groups in each LED module 44, and the LED elements 46 in the same group are connected in serial to each other.

As shown in FIGS. 1 and 3, an upper cooling mechanism 48 is disposed above the LED modules 44. The upper cooling mechanism 48 includes a coolant passage 50 of a rectangular section, which is disposed in the element attachment head 36. A coolant inlet pipe 50A is connected to a coolant inlet 51 on one end of the coolant passage 50, and a coolant discharge pipe 50B is connected to a coolant outlet 53 on the other end of the coolant passage 50. By causing a coolant to flow through the coolant passage 50, heat generated by the LED modules 44 is drawn therefrom, whereby the LED modules 44 can be cooled. Fluorinert (brand name) or Galden (brand name) may be used as a coolant. The coolant passage 50 is arranged in a meandering way, for example, over substantially all the surface of the element attachment head 36, so that heat can be effectively drawn from the upper surfaces of the LED modules 44 so as to cool the same.

As shown in FIGS. 1 and 3, a vertically extending heat pipe 52 of an opened rectangular shape is embedded around opposed side walls of each coolant passage 50. Thus, the LED modules 44 can be more efficiently cooled.

Further, a control box 54 for feeding power is disposed above the ceiling plate 4B. Control boards 56 corresponding to the respective LED modules 44 are provided in the control box 54. Feed lines 58 are extended from the control boards 56 to the respective LED modules 44, whereby power can be fed to the respective LED modules 44.

<Description of Rear-Side Heating Unit>

Next, the rear-side heating unit 34 is described. A thick light transmitting plate 62 formed of, e.g., a transparent quartz glass plate is hermetically attached to the opening of the bottom plate 4C via a sealing member 64 such as an O-ring by means of a fixing tool 66. The rear-side heating unit 34 includes a plurality of laser modules 60 arranged below the light transmitting plate 62. Specifically, a laser attachment casing 61 is attached so as to cover a lower part of the light transmitting plate 62 fitted in the opening of the bottom plate 4C. The plurality of laser modules 60 are securely fixed to the laser attachment casing 61.

As shown in FIG. 4, the laser modules 60 are substantially uniformly dispersed over all the surface of a range that is large enough to cover at least the overall rear surface of the wafer W. In this case, the dimensions of each laser module 60 are set as about 50 mm×60 mm×25 mm, for example, which are considerably larger than the dimensions of the LED module 44. Since an output of each laser module 60 is large, it is not necessary to arrange the laser modules 60 densely, unlike the LED modules 44.

Thus, when the diameter of the wafer W is 300 mm, about 50 to 100 laser modules 60 are provided. Each laser module 60 has one laser element 68 and a cooling part 70 as a cooling mechanism. Therefore, the laser elements 68 are arranged over a range that is large enough to cover the overall rear surface of the wafer W. As shown in FIG. 5, the laser element 68 has a light emitting layer 72 sandwiched between two electrodes. An irradiation area 74 of laser beams, i.e., heating light beams L1 emitted from the light emitting layer 72 is of an elliptical shape having a major axis perpendicular to a direction in which the light emitting layer 72 is extended.

In this case, an expansion angle of the heating light beams L1 in the major axial direction is about 30 to 50 degrees, and an expansion angle thereof in the minor axial direction is 10 degrees or less. Thus, as shown in FIG. 6, in order to heat the rear surface of the wafer W with an in-plane uniformity, the major axial direction of the elliptic irradiation area 74 is preferably set to correspond to the radial direction of the wafer W. It is preferable that a light emitting wavelength of the laser element 68 is a range between ultraviolet light and near infrared light, e.g., a specific wavelength in a range between 360 and 1000 nm, in particular, a specific wavelength (monochromatic light) in a range between 800 and 970 nm, which is absorbed by the wafer W formed of a silicon substrate at a high absorptance. To be specific, a semiconductor laser element using, e.g., GaAs may be used as the laser element 68. Herein, the arrangement of the laser modules 60 shown in FIG. 4 is a mere example, and the present invention is not limited thereto.

Returning to FIG. 1, a feed line 76 is connected to each laser element 68 of the laser module 60, so that power is fed thereto. The respective cooling parts 70 of the laser modules 60 are connected in serial to each other by coolant passages 78. A coolant inlet pipe 80 is connected to the cooling part 70 on the most upstream side, and a coolant discharge pipe 82 is connected to the cooling part 70 on the most downstream side. By causing a coolant to flow through the cooling parts 70, the laser modules 60 can be cooled. Fluorinert (brand name) or Galden (brand name) may be used as a coolant.

A reflection surface 84 whose surface has been treated is formed on an inner side surface of the laser attachment casing 61. Thus, heating light beams reflected on the rear surface of the wafer W can be again reflected upward. Herein, the laser module 60 in which the laser element 68 and the cooling part 70 are integrated with each other is described by way of example, but there may be employed a structure in which the laser element 68 and the cooling part 70 are separated from each other.

To control the operations of the annealing apparatus 2 as structured above, e.g., to control a process temperature, a process pressure, a gas flow rate, and turning on and off of the front-side heating unit 32 and the rear-side heating unit 34 is performed by a control part 86 formed of a computer, for example. A computer-readable program required for this control is generally stored in a storage medium 88. As the storage medium 88, there may be used a flexible disc, a CD (Compact Disc), a CD-ROM, a hard disc, a flash memory, or a DVD.

Next, an annealing process performed by the annealing apparatus 2 as structured above is described. At first, a semiconductor wafer W formed of, e.g., a silicon substrate is loaded by a transfer mechanism, not shown, from a load lock chamber or a transfer chamber already in a reduced pressure atmosphere, not shown, via the opened gate valve 8, into the processing vessel 4 already in a reduced pressure atmosphere.

A surface condition of the wafer W is as follows. Namely, as aforementioned, the amorphous silicon portion, the metal portion and/or the oxidation film are formed on the front surface of the wafer W, i.e., various small regions of different absorptances with respect to a wavelength of a heating light beam are formed on the surface of the wafer W. By causing the elevating arms 14 to vertically move, the loaded wafer W is placed on the support pins 12 disposed on the elevating arms 14. Thereafter, the transfer mechanism is withdrawn, and the gate valve 8 is closed so that the processing vessel 4 is hermetically sealed.

Then, a process gas such as N₂ gas or Ar gas is made to flow from the gas pipe 20 of the gas supply unit 16, while a flow rate of the gas being controlled, and the inside of the processing vessel 4 is maintained at a predetermined pressure. At the same time, the front-side heating unit 32 disposed on the ceiling plate 4B and the rear-side heating unit 34 disposed on the bottom plate 4C are turned on. Thus, the LED elements 46 of the front-side heating unit 32 and the laser elements 68 of the rear-side heating unit 34 are lighted on, so that heating light beams are irradiated therefrom. By these heating light beams, the wafer W is heated from both above and below so as to be annealed. In this case, the process pressure is about 100 to 10000 Pa, for example. The process temperature (wafer temperature) is about 800 to 1100° C. The lighting period of the LED elements 46 and the lighting period of the laser elements 68 are respectively about 1 to 10 seconds.

The front surface (upper surface) of the wafer W is heated by the heating light beams irradiated from the respective LED elements 46. Since the light emitting wavelength of the heating light beams has a certain degree of width, the front surface of the wafer W can be heated with an in-plane temperature of the surface being substantially uniform, independently of the surface condition of the wafer W.

On the other hand, the heating light beams of monochromatic light are irradiated onto the rear surface (lower surface) of the wafer W from the respective laser elements 68. As shown in FIG. 6, due to the irradiated beams, the elliptical irradiation areas 74 are formed in a substantially uniformly dispersed manner over all the rear surface of the wafer W. In this case, as described above, the heating light beams L1 (see, FIG. 5) irradiated from the laser elements 68 are monochromatic light beams, and the condition of the rear surface of the wafer W is uniformed by silicon or silicon oxide. The wavelength of the heating light beams L1 is set as a wavelength absorbed by silicon or silicon oxide at a high absorptance, e.g., a predetermined wavelength in a range between 360 and 1000 nm, more preferably, a predetermined wavelength in a range between 800 and 970 nm. Thus, the rear surface of the wafer can be heated, with the in-plane temperature of the surface being substantially uniform. That is to say, the wafer W can be uniformly, promptly heated in a short period of time, from both the front surface side and the rear surface side, with the in-plane temperatures of the surfaces being highly uniform.

In addition, an energy conversion efficiency of the laser element 68 (light conversion ratio: e.g., 40 to 50%) used in the rear-side heating unit 34 is higher than that of the LED element 46 (light conversion ratio: e.g., 10 to 30%) used in the front-side heating unit 32. Thus, as compared with a case in which the LED elements are used in the rear-side heating unit, it can be said that the energy saving is contributed to.

Further, since the wafer W is heated from both the front surface (upper surface) side and the rear surface (lower surface) side by the front-side heating unit 32 and the rear-side heating unit 34, bias (ununiformity) of temperature distribution in the thickness direction of the wafer W rarely occurs. Thus, the wafer W can be prevented from warping, which might be caused by a difference between temperatures of the front and rear surfaces of the wafer W.

Furthermore, although the element attachment head 36 is heated by a large amount of heat generated by the front-side heating unit 32, the element attachment head 36 can be efficiently cooled by causing a coolant to flow through the coolant passages 50 of the upper cooling mechanism 48 disposed on the element attachment head 36. In this case, as shown in FIGS. 1 and 3, since the heat pipes 52 are disposed along the height direction of the coolant passages 50, the heat conversion efficiency at this portion can be further increased, so that the cooling efficiency of the element attachment head 36 can be further improved. For example, when copper is used as a material of the element attachment head 36, the heat conductivity is 300 to 350 W/m·deg. On the other hand, due to the provision of the heat pipes 52, the heat conductivity can be enhanced up to 400 to 600 W/m·deg.

In addition, a large amount of heat is similarly generated by the rear-side heating unit 34, so that the laser elements 68 have a high temperature. However, the heat can be removed by causing a coolant to flow through the cooling parts 70 as the cooling mechanism disposed on the respective laser modules 60, whereby the respective laser elements 68 can be efficiently cooled.

Herein, although both the front-side heating unit 32 and the rear-side heating unit 34 are provided, only the rear-side heating unit 34 may be provided by omitting the front-side heating unit 32, as described above. In this case, the temperature increasing rate is slightly degraded as compared with the case in which both the heating units 32 and 34 are provided. However, also in this case, the wafer W can be promptly heated as a whole, with the in-plane temperature thereof being highly uniform.

As described above, the rear-side heating unit 34 having the plurality of laser elements 68 is provided on the annealing apparatus configured to anneal an object to be processed, e.g., a semiconductor wafer W. By irradiating the laser beams serving as the heating light beams L1 onto the object to be processed from the rear surface thereof whose surface condition is uniform, the object to be processed can be heated in a short period of time, with an in-plane temperature thereof being uniform. Further, due to the excellent energy conversion efficiency of the laser element, energy can be saved.

<Alternative Example of Rear-Side Heating Unit>

In the above description about the rear-side heating unit, each laser module 60 has one laser element. In this example, a plurality of, specifically, three laser elements 68 in one group are mounted on each laser module 160 so as to make a unit. The plurality of laser modules 160 are densely arranged in combination in a plane. As shown in FIG. 14, the laser module 160 includes a cylindrical housing 194 having a polygonal shape, i.e., a regular hexagonal shape. Three laser elements 68 are arranged in parallel with each other in the housing 194, so that laser beams serving as heating light beams can be outputted from an upper end surface of the housing 194.

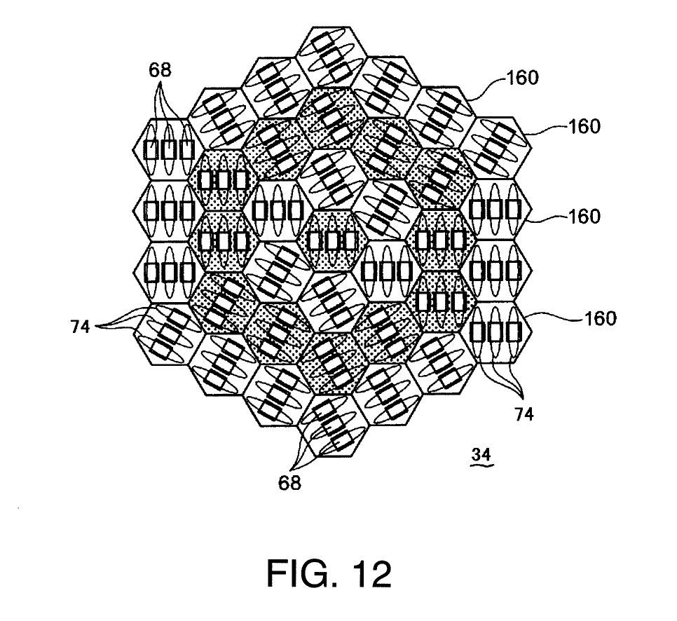

In the example shown in FIG. 12, the laser modules 160 of a regular hexagonal shape, whose number is 37 in total, are densely arranged substantially concentrically, such that the edges of the laser modules 160 are adjacent to each other. Thus, the number of the laser elements 68 is 111. FIG. 12 also shows the elliptical irradiation areas 74 formed by the laser beams serving as the heating light beams outputted from the respective laser elements 68.

In this example, as shown in FIG. 14, the three laser elements 68 are mounted on the laser module 160 such that the laser elements 68 are arranged in parallel with longitudinal directions thereof being perpendicular to a line connecting a pair of opposed angles. The three laser elements 68 are electrically connected in serial in the laser module 160, and two feed lines 76 are extended from the laser module 160 so as to feed power.

In the laser module 160, the cooling part 70 is integrated thereto in order to cool the heat generated from the laser elements 68. The cooling part 70 is provided with a flexible coolant inlet pipe 202 and a flexible coolant outlet pipe 204 through which a coolant flows (see, FIG. 14). The coolant inlet pipe 202 and the coolant outlet pipe 204 are connected in serial to each other between the adjacent laser modules 160. Thus, a coolant can serially flow through all the cooling parts 70 of the laser modules 160.

The coolant introduction pipe 80 is connected to the cooling part 70 on the most upstream side, and the coolant discharge pipe 82 is connected to the cooling part 70 on the most downstream side (see, FIG. 1). By causing a coolant to flow therethrough, the laser modules 160 can be cooled. Fluorinert (brand name) or Galden (brand name) may be used as a coolant.

As has been described with reference to FIG. 12, the laser modules 160 of a regular hexagonal shape are densely arranged substantially concentrically over a range that is large enough to cover the overall rear surface of the semiconductor wafer W. The respective laser modules 160 can be independently pulled from the laser attachment casing 61 so as to be detachable therefrom and attachable thereto. Mounting angles of the respective laser modules 160 can be independently adjusted.

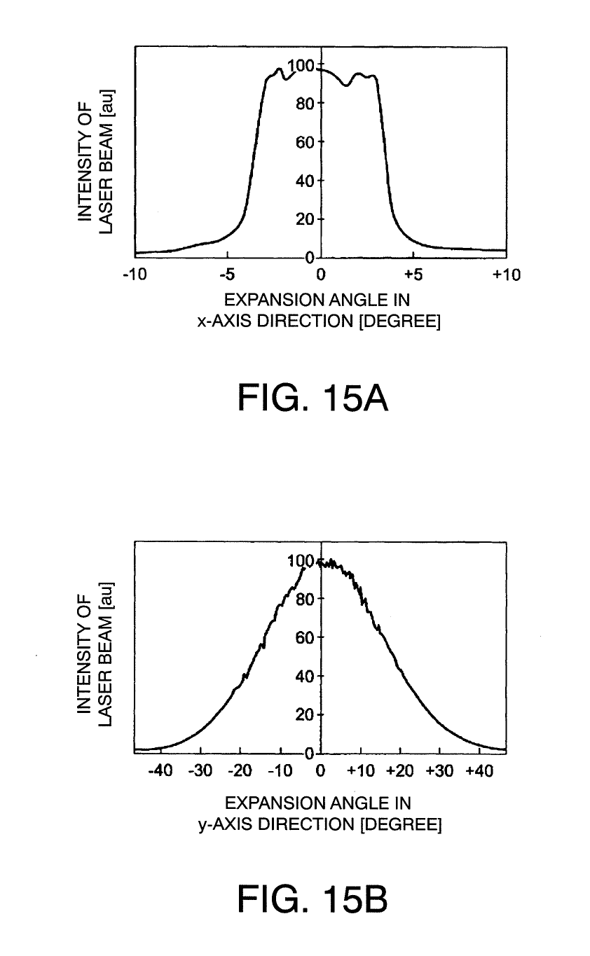

In this example, as shown in FIG. 15A, an expansion angle of the heating light beams L1 in the minor axial direction is not more than ±10 degrees. As shown in FIG. 15B, an expansion angle thereof in the major axial direction is about ±15 to ±25 degrees. Thus, as shown in FIG. 12, in order to heat the rear surface of the wafer W with an in-plane temperature being uniform, the elliptical irradiation areas 74 are set such that the major axial directions thereof are oriented along the circumferential direction of the wafer W as much as possible.

To be specific, as described above, in this example, the laser modules 160 are concentrically arranged, and are concentrically separated into four zones. The innermost zone is composed of one laser module 160 positioned on the central portion. The second inner zone outside the innermost zone is composed of six laser modules 160. The third inner zone outside the second inner zone is composed of twelve laser modules 160. The outermost zone outside the third inner zone is composed of eighteen laser modules 160.

The respective laser modules 160 are attachable and detachable such that the mounting angles (rotational positions) thereof can be adjusted. Thus, the mounting angles (rotational positions) of the respective laser modules 160 are adjusted such that the major axes of the elliptical irradiation areas 74 formed by the laser elements 68 mounted on the laser modules 160 are oriented along the circumferential direction of the wafer W as much as possible. In this example, since the housing 194 of the laser module 160 has a regular hexagonal shape, the mounting angle can be adjusted at every 60 degrees.

Among the laser modules 160 in the respective four zones, all or some of the laser modules 160 are obliged to be attached in such a manner that the major axial directions of the irradiation areas 74 do not completely correspond to the circumferential direction of the wafer W. However, by rotating the laser modules 160 by, e.g., 60 degrees to adjust the mounting angles thereof, the laser modules 160 can be mounted such that an angle defined between the circumferential direction (tangential direction) of the wafer W and each major axial direction becomes small as much as possible. Because of the properties of the laser module 160 in the innermost zone, the mounting angle thereof is not limited. Regardless of the direction of the laser module 160 in the innermost zone, the expansion of the irradiation area with respect to the second inner zone outside the innermost zone is unchanged.

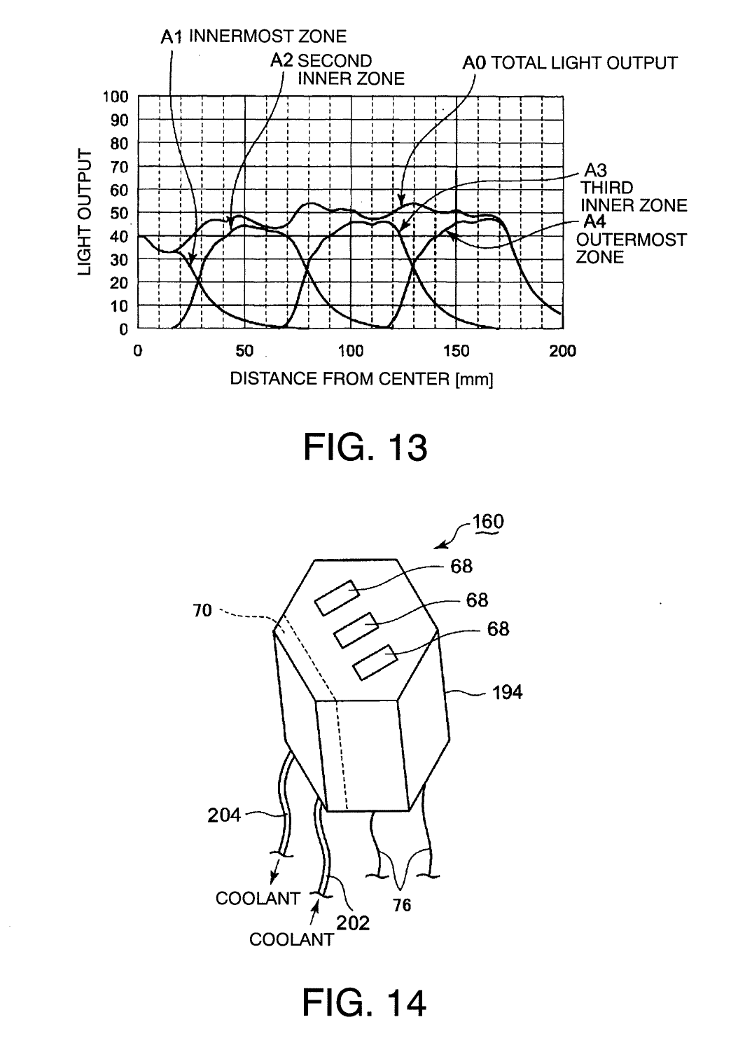

FIG. 13 shows a relationship between the radial direction (distance) of the wafer W having a diameter of 300 mm, light outputs from the respective zones, and a total light output of the respective zones. In the graph of FIG. 13, the curve A1 depicts a light output from the innermost zone, the curve A2 depicts a light output from the second inner zone, the curve A3 depicts a light output from the third inner zone, the curve A4 depicts a light output from the outermost zone, and the curve A0 depicts a total light output which is a sum of the curves A1 to A4.

As apparent from the graph, the peaks of the light outputs in the respective zones are precipitous. Directivities of the heating light beams of each zone are high, and the heating light beams do not so much expand toward the adjacent zone. Thus, as shown by the curve A0, the total light output is substantially constant, i.e., the total light output is not so varied over all the radial directions from the center of the semiconductor wafer. Thus, it can be understood that the high in-plane uniformity of the irradiation amount of the heating light beams can be achieved.

Herein, it is preferable that a light emitting wavelength of the laser element 68 is a range between ultraviolet light and near infrared light, e.g., a specific wavelength in a range between 360 and 1000 nm, in particular, a specific wavelength (monochromatic light) in a range between 800 and 970 nm, which is absorbed by the wafer W formed of a silicon substrate at a high absorptance. A semiconductor laser element using, e.g., GaAs may be used as the laser element 68. Herein, the arrangement of the laser modules 160 shown in FIG. 12 is a mere example. The arrangement is not limited thereto.

Powers of the laser modules 160 each including three laser elements 68 are independently controlled depending on the four zones. Since the light beams are irradiated such that the major axial direction of each elliptical irradiation area 74 having a high directivity is oriented along the circumferential direction of the wafer W, the expansion of the irradiation area 74 in the radial direction of the wafer W is considerably narrow. Thus, as shown in FIG. 13, the temperature controllability of each zone can be enhanced. As a result, as shown by the curve A0 of the total light output in FIG. 13, the irradiation amount from the center of the wafer W to the peripheral part thereof can be relatively made uniform, whereby the in-plane temperature uniformity of the wafer W can be improved.

In addition, as described above, since the light beams are irradiated such that the major axial direction of each elliptical irradiation area 74 is oriented along the circumferential direction of the wafer W, the light is prevented from leaking outside the wafer W, whereby the light energy can be efficiently used.

When the temperature distribution in the plane of the wafer changes because of a long term of use, or when the temperature distribution is to be minutely adjusted for performing another heat process, the laser modules 160 corresponding to the relevant portion are independently pulled out from the laser attachment casing 61, and the laser modules 160 are rotated by, e.g., 60 degrees and again attached thereto. Namely, by changing the mounting angles, the laser modules 160 can be adjusted so as to obtain an optimum distribution of the irradiation amount of the heating light beams L1.

<Alternative Embodiment of Arrangement of Laser Modules>

Next, an alternative embodiment of the arrangement of the laser modules of the rear-side heating unit is described. As shown in FIG. 12, in the above-described embodiment, the mounting angles of the respective laser modules 160 are adjusted for irradiation such that the major axial directions of the elliptical irradiation areas 74 are oriented along the circumferential direction of the wafer W as much as possible. However, not limited thereto, the major axial directions of the irradiation areas 74 may be oriented along the radial direction of the wafer for irradiation.

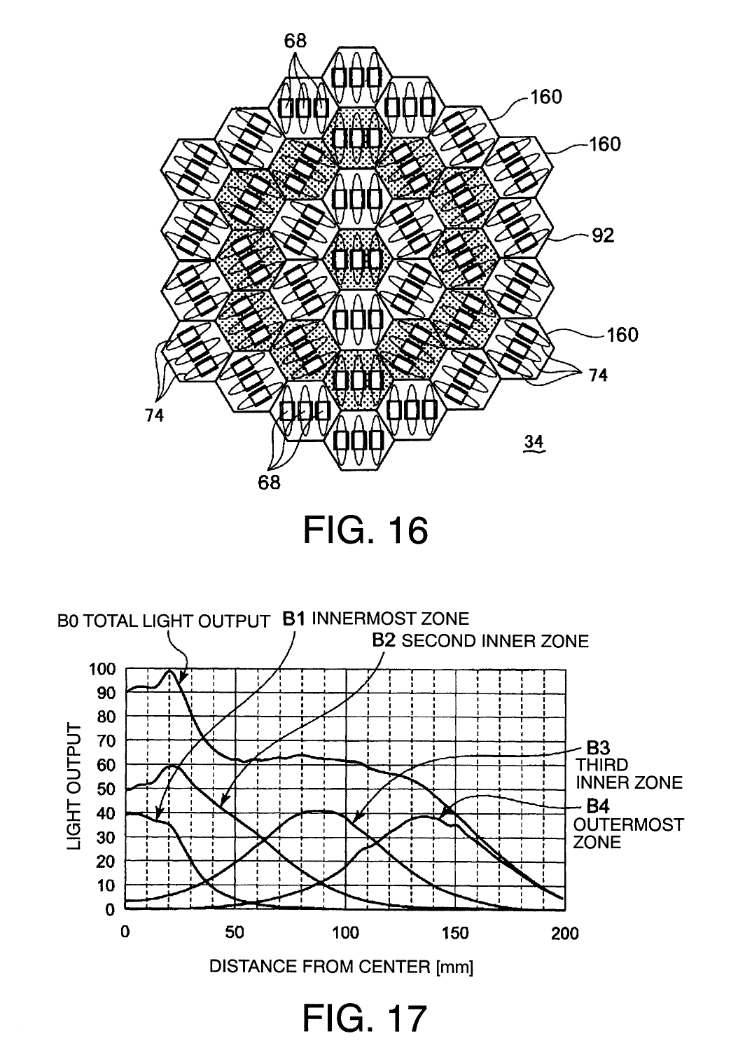

FIG. 16 is a plan view showing an example of another embodiment of the arrangement of the laser modules of the rear-side heating unit. FIG. 17 is a graph showing a distribution of heating light beams (light outputs) outputted from the rear-side heating unit shown in FIG. 16. As described above, in this embodiment, the mounting angles (rotational positions) are adjusted such that the major axes of the elliptical irradiation areas 74 formed by the laser elements 68 of the respective laser modules 160 of the rear-side heating unit 34 are oriented in the radial direction of the wafer W as much as possible. Also in this embodiment, some of the laser modules 160 in the respective four zones are obliged to be attached in such a manner that the major axial directions of the irradiation areas 74 do not completely correspond to the radial direction of the wafer W.

FIG. 17 shows a distribution of light outputs from the respective zones of the rear-side heating unit 34 at this time. The curve B1 depicts a light output from the innermost zone, the curve B2 depicts a light output from the second inner zone, the curve B3 depicts a light output from the third inner zone, the curve B4 depicts a light output from the outermost zone, and the curve B0 depicts a total light output which is a sum of the curves B1 to B4.

As apparent from the graph, as compared with the case shown in FIG. 13, the peaks of the light outputs in the respective zones are moderate. Directivities of the heating light beams of each zone are low, and the heating light beams considerably expand toward the adjacent zone. Thus, as shown by the curve B0, the total light output is relatively high at the central part of the semiconductor wafer, and gradually lowers toward the radial direction thereof. Thus, in this embodiment, as compared with the embodiment described with reference to FIGS. 12 and 13, it can be understood that, although the in-plane uniformity of the irradiation amount of the heating light beams is somewhat degraded, the in-plane uniformity of the irradiation amount of the heating light beams can be enhanced to a certain degree nevertheless.

The mounting angles of the respective laser modules 160 shown in FIGS. 12 and 16 are extreme cases for showing the mere examples, respectively. The mounting angles of the laser modules 160 are not limited thereto as a matter of course.

<Alternative Embodiment of Laser Module>

Next, an alternative embodiment of the laser module 160 is described. In the aforementioned laser module 160 shown in FIG. 14, the three laser elements 68 are arranged in parallel such that the longitudinal directions thereof are perpendicular to a line connecting a pair of opposed angles. However, not limited thereto, three laser elements 68 may be arranged such that the longitudinal directions thereof are perpendicular to a line perpendicular to a pair of opposed edges.

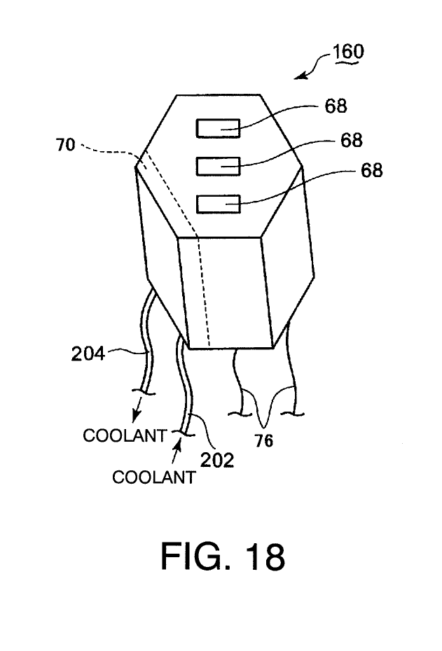

FIG. 18 is an enlarged perspective view of an example of such an alternative embodiment of the laser module. As shown in FIG. 18, three laser elements 68 are mounted on the laser module 160 such that the longitudinal directions of the laser elements 68 are perpendicular to a line perpendicular to a pair of opposed edges. The laser modules 160 formed in this manner may be arranged in the manner as shown in FIG. 12 or 16.

Further, it is possible to arrange the laser modules 160 shown in FIG. 14 and the laser modules 160 shown in FIG. 18 in combination. For example, in FIG. 12, the laser modules 160 shown in FIG. 14 may be applied to the second inner zone, and the laser modules 160 shown in FIG. 18 may be applied at positions where the major axial directions of the irradiation areas 74 differ largely from the circumferential direction of the wafer W in the third inner zone and the outermost zone. According to this structure, the amount of the heating light beams expanding in the radial direction of the wafer W can be further decreased, whereby the light energy can be more efficiently utilized.

In the above respective embodiments, the number of the laser elements 68 mounted on one laser module 160 is three, which is merely an example. The number thereof is not limited to three as a matter of course. In addition, the laser module 160 has a regular hexagonal shape. However, not limited thereto, the laser module 160 may have another polygonal shape, such as a regular triangular shape, a regular pentagonal shape or a regular octagonal shape.

<Alternative Example of Heat Pipe>

As shown in FIG. 3, in the above embodiment, the heat pipe 52 disposed in the element attachment head 36 is completely buried outside the coolant passage 50. However, not limited thereto, the heat pipe may be structured as shown in FIG. 7, for example. FIG. 7 is an enlarged perspective view of one of the coolant passages 50 of the upper cooling mechanism of the element attachment head.

In this example, an upper end of the heat pipe 52 of an opened rectangular shape is exposed to the upper part in the coolant passage 50. A plurality of (a number of) such heat pipes 52 are arranged at substantially equal pitches along a flow direction of the coolant passage 50. According to this manner, since the upper end of each heat pipe 52 directly contact the coolant, the heat exchange effectiveness for cooling can be further improved, whereby the cooling efficiency can be improved.

<Alternative Embodiment>

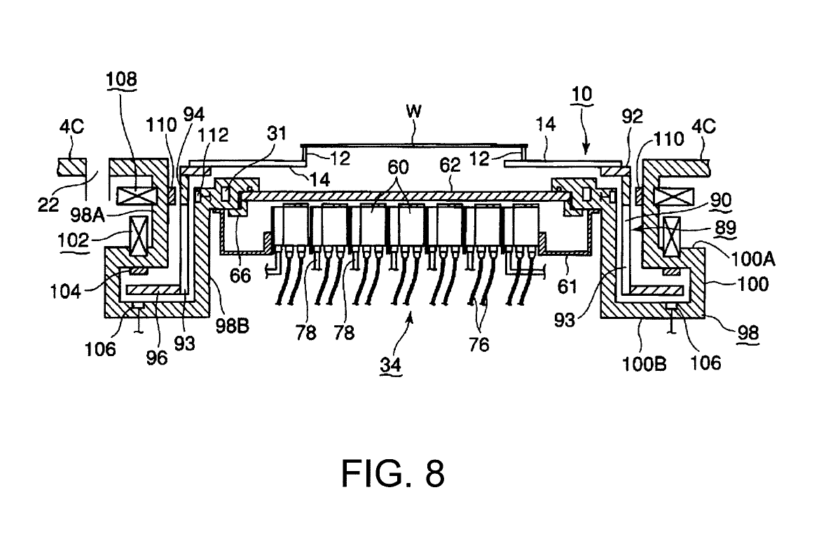

Next, an alternative embodiment of the annealing apparatus according to the present invention is described. In the above embodiment, since the positions of the irradiation areas 74 irradiated on the rear surface of the semiconductor wafer W are fixed, there is a possibility that a slight temperature distribution might occur in the in-plane direction of the wafer W. Thus, in this alternative embodiment, the irradiation areas 74 can be relatively scanned (moved), whereby the uniformity of the wafer temperature in the in-plane direction can be further improved. FIG. 8 is a partial structural view showing a lower part of a processing vessel including a support unit in the alternative embodiment of the annealing apparatus. In FIG. 8, the same constituent members as those shown in FIG. 1 are shown by the same reference numbers, and a detailed description thereof is omitted.

In order to relatively scan (move) the irradiation areas 74, a support unit 10 for supporting a semiconductor wafer W is attached to a rotational mechanism 89 so as to be rotated. Namely, in this embodiment, the support unit 10 for supporting the wafer W is integrally formed with a rotational floating member 90 that constitutes a part of the rotational mechanism 89. Proximal ends of respective elevating arms 14 of the support unit 10 are fixedly secured to a ring-like member 92. On the other hand, a plurality of vertically extending strip-like columns 93 are arranged at equal pitches along a circumferential direction of an imaginary cylindrical body. Upper ends of the columns 93 are joined to a floating-side upper ferromagnetic member 94. Further, the ring-like member 92 is connected to the floating-side upper ferromagnetic member 94.

Lower ends of the respective columns 93 are joined to a floating-side lower ferromagnetic member 96 of a circular ring shape. The floating-side lower ferromagnetic member 96 of a circular ring shape is horizontally extended like a flange. Due to this structure, the rotational floating member 90 can be moved upward and downward while the rotational floating member 90 is floating, so that support pins 12 supporting the wafer W can be elevated and lowered.

Joined to a bottom plate 4C on the bottom of the processing vessel 4 is an accommodating part for floating 98 of a dual cylindrical structure. Inside the accommodating part for floating 98, there is formed a space that is large enough to accommodate the rotational floating member 90 and to allow a vertical movement of the rotational floating member 90 by a predetermined stroke. A lower region of the accommodating part for floating 98 defines a horizontal accommodating part 100 that is large enough to accommodate the floating-side lower ferromagnetic member 96 and to allow a vertical movement of the floating-side lower ferromagnetic member 96 by a predetermined stroke.

A plurality of electromagnetic assemblies for floating 102 are arranged at predetermined pitches on an upper surface of an upper partition wall 100A defining the horizontal accommodating part 100 along a circumferential direction thereof. Further, a ferromagnetic member 104 is provided on a lower surface of the upper partition wall 100A. Furthermore, a vertical position sensor 106 is provided on a side of an inner surface (upper surface) of a lower partition wall 100B defining the horizontal accommodating part 100, such that the floating-side lower ferromagnetic member 96 is interposed between the vertical position sensor 106 and the ferromagnetic member 104.

Therefore, by adjusting an electromagnetic force of the electromagnetic assemblies for floating 102 while detecting a height position of the floating-side lower ferromagnetic member 96 by the vertical position sensor 106, the support unit 10 can be set at a given height. In this case, the plurality of vertical position sensors 106 are circumferentially disposed, so as to prevent inclination of the rotational floating member 90.

Herein, a position 2-mm above a position where the rotational floating member 90 is in contact with the bottom plate is set as a home position. The rotation control is performed at the home position. In addition, a position 10-mm above the home position, for example, is set as a transfer position where wafers W are received and delivered.

In addition, outside an outer peripheral wall 98A of the accommodating part for floating 98, a plurality of electromagnetic assemblies for rotation 108 are arranged at predetermined pitches along a circumferential direction of the outer peripheral wall 98A. A ferromagnetic member 110 is provided inside the outer peripheral wall 98A. A horizontal position sensor 112 is provided on an outer circumferential side of an inner peripheral wall 98B of the accommodating part for floating 98, such that the floating-side upper ferromagnetic member 94 is interposed between the horizontal position sensor 112 and the ferromagnetic member 110. Therefore, by applying a rotational magnetic field to the electromagnetic assemblies for rotation 108 while detecting a horizontal position of the floating-side upper ferromagnetic member 94 by the horizontal position sensor 112, the rotational floating member 90 can be rotated while the rotational floating member 90 is located at the home position.

As described above, the wafer W can be rotated while the wafer W is supported on the rotational floating member 90. Thus, the elliptical irradiation areas 74 shown in FIG. 6, which are irradiated on the rear surface of the wafer W, can be relatively rotated and moved in the circumferential direction of the wafer W. Therefore, the uniformity of the in-plane temperature of the wafer W can be further improved.

In addition, by rotating the wafer W in this manner, non-uniformity of a heat condition in the circumferential direction of the inner wall surface of the processing vessel 4 can be cancelled. This advantage can also improve the uniformity of the in-plane-temperature of the wafer W. The aforementioned structure of the rotational mechanism 89 is shown merely by way of example, and is not limited thereto. For example, a rotational mechanism disclosed in JP2002-280318A may be used. Moreover, although the semiconductor wafer W is rotated in this embodiment, the rear-side heating unit 34 may be rotated instead thereof.

<Alternative Example of Cooling Mechanism>

In the aforementioned cooling mechanism 48, the LED modules 44 are cooled by causing a coolant to flow through the coolant passages 50 so as to draw heat from the upper surfaces of the LED modules 44. The superficial dimensions of the rectangular flow-path sections of the coolant passages 50 are set to be constant along the flow direction of the coolant passages 50. Thus, at a location near to the coolant inlet, the coolant sufficiently draws heat from the LED modules 44 as objects to be cooled, so that the LED modules 44 can be efficiently cooled. However, it is considered that, since the temperature of the coolant increases as the coolant flows downward, the cooling efficiency gradually decreases.

Namely, the cooling efficiency varies along the flow direction of the coolant passages 50. Thus, there is a possibility that a temperature distribution might be biased depending on the arrangement positions of the LED modules 44 as objects to be cooled, resulting in a temperature non-uniformity. That it to say, there is a possibility that, while the LED modules 44 arranged on the upstream side of the coolant passages 50 can be efficiently cooled, the LED modules 44 arranged on the downstream side cannot be efficiently cooled, resulting in a non-uniformity of the temperature distribution of the LED modules 44.

Thus, in the alternative example of the cooling mechanism, in order to eliminate the possibility, the superficial dimensions of the flow-path sections of the coolant passages 50 are set so as to be sequentially reduced from the coolant inlet 51 toward the coolant outlet 53. Thus, the cooling efficiency can be made constant along the flow direction of the coolant passages 50, whereby the overall temperature of the objects to be cooled can be maintained to be constant so as to prevent the temperature non-uniformity.

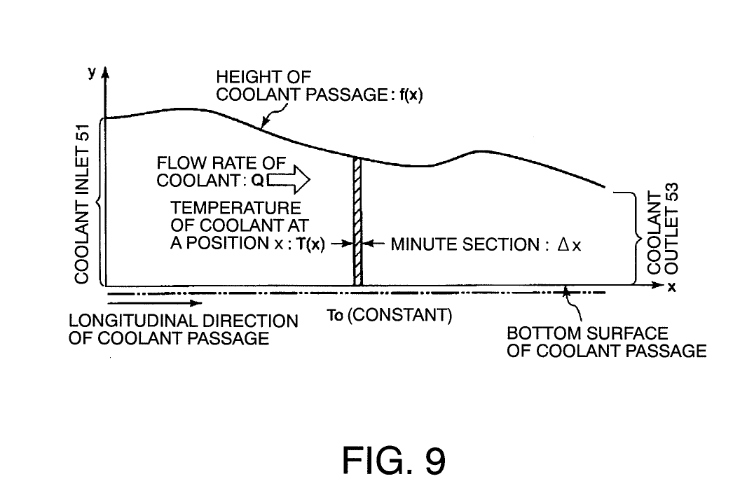

A principle of making constant the cooling efficiency along the flow direction of the coolant passages 50 so as to maintain constant the temperatures of objects to be cooled is described. FIG. 9 is a schematic view for obtaining a temperature variation of a coolant in a minute section in a longitudinal direction of the coolant passages. Herein, in order to facilitate understanding of the present invention, a simulation was performed on the assumption that the widths of the coolant passages were constant (unit length=1 m) and that the heights of the coolant passages were represented as a function “f(x)”. In FIG. 9, the axis of abscissa “x” shows a distance from the coolant inlet 51 toward the coolant outlet 53, and the axis of ordinate “y” shows the height “f(x)” of the coolant passage 50.

It is assumed that the coolant flows at a flow rate “Q” from the coolant inlet 51 toward the coolant outlet 53. The temperature of the coolant at a position of distance “x” is represented as “T(x)”. When a requirement for maintaining the temperatures of the bottom surfaces of the coolant passages 50 along the x axis at a temperature To is satisfied, the temperatures of the objects to be cooled can be maintained constant along the flow direction of the coolant passages 50.

A heat transfer rate h of the coolant is represented by the below Expression 1.

h=0.664(ρ^{1/2})(μ^{-1/6})(cp^{1/3})(k^{2/3})(L^{-1/2})(u^{1/2}) (1)

wherein
ρ: density of coolant (kg/m³);
μ: viscosity of coolant (kg/m·sec);
cp: specific heat of coolant (J/kg·K);
k: heat conductivity of coolant (W/m·K);
L: length of cooling part (m); and
u: velocity of coolant (m/sec).

Provided that the temperature does not vary so much, the parameters other than the velocity of the coolant can be represented as a constant A, and thus the heat transfer rate can be regarded as a function of only the velocity of the coolant.

That is to say, the constant A is defined as follows.

0.664(ρ^{1/2})(μ^{-1/6})(cp^{1/3})(k^{2/3})(L^{-1/2})=A(constant)

In FIG. 9, when a heating quantity flowing into the coolant when the coolant moves forward a distance Δx is “W”, “W” is represented by the below Expression 2.

$$\begin{matrix}W = \{ T ( x + Δ x ) - T ( x ) \} \cdot cp \cdot ρ \cdot Δ x \cdot f ( x ) \\ = A \cdot Δ x \cdot ( To - T ( x ) ) \cdot Δ t \sqrt{ } u ( x )\end{matrix} \qquad ( 2 )$$

wherein
cp: specific heat of coolant;
ρ: density of coolant;
u(x): velocity of coolant at position x;
Δt: period required for coolant to make forward distance Δx; and
A: constant for obtaining heat transfer rate.

By organizing the above Expression with Δt/Δx=1/u(x) and u(x)=Q/f(x), the below Expression 3 is obtained.

cp·ρ·(T(x+Δx)−T(x))/Δx=A·(To−T(x))/√(Q·f(x)) (3)

By organizing Expression 3, the below Expression 4 is obtained.

f(x)=A²·(To−T(x))²/(Q·cp²·ρ²·(T′(x))²) (4)

Herein, note that “T′(x)=(T(x+Δx)−T(x))/Δx”.

Namely, the height function f(x) of the coolant passage 50 is dependent on the temperature variation T(x) of the coolant. In other words, when the temperature variation is determined, the height of the coolant passage 50 is automatically determined.

When concrete numerical examples are assigned to Expression 4, the following Expression 5 is obtained. The concrete numerical examples are as follows.

Flow rate of Coolant Q: 2 litters/min (=2×10⁻³/60 m³/sec);

### Target Temperature To: 100° C.;

### Width of Coolant Passage: 10 mm;

### Length of Coolant Passage: 5 m;

Temperature at Coolant Inlet: −50° C., Temperature at Coolant outlet −40° C. (on the assumption that the temperature variation is a primary variation, “T(x)=2·x−50”);

### Specific Heat of Coolant cp: 1000 J/kg·k;

Density of Coolant ρ: 1800 kg/m³; and

### Constant A: 230.

In consideration of the system of units and the width of the coolant passage, the coolant flow rate Q is converted to a unit [m³/sec]. In addition, since the width of the coolant passage was set as the unit length 1 m (=1000 mm) in the above simulation, f(x) is multiplied by 1/100 in order to convert the width into the 10 mm width of the coolant.

f(x)=230²·[100−(2·x−50)]²/[(2×10⁻³/60)×1000²×1800²×2²×100] (5)

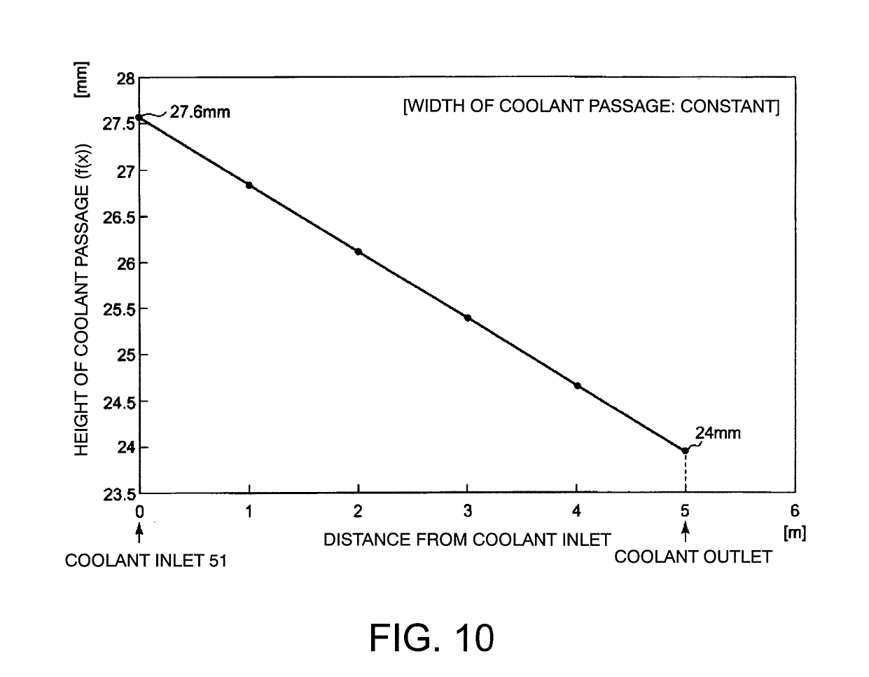

The graph of Expression 5 is shown in FIG. 10. Namely, the graph corresponds to an embodiment in which the height of the coolant passage 50 at the coolant inlet 51 is set to be about 27.6 mm, the heights of the passages 50 are sequentially decreased in accordance with the distance from the coolant inlet 51, and the height of the coolant passage 50 at the coolant outlet 53 is set to be about 24 mm.

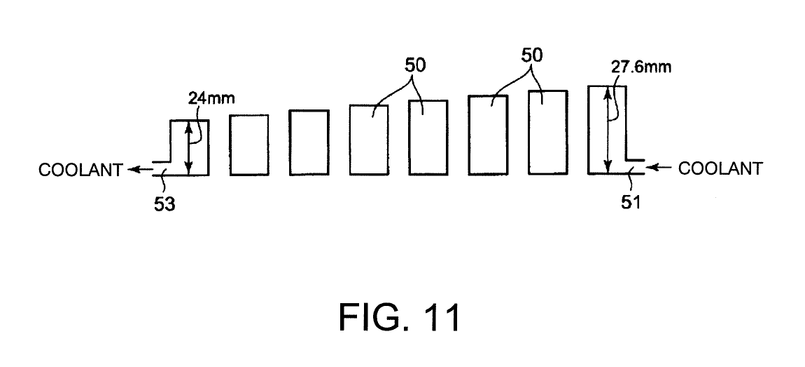

FIG. 11 shows an example of a change of the heights of the sectional shapes of the coolant passages 50 corresponding to this embodiment. Herein, the heights of the coolant passages 50 are sequentially reduced as a measuring point comes downstream. Needless to say, the velocity of the coolant gradually increases as the measuring point comes downstream.

It can be understood that, by setting the heights of the coolant passages 50 such that the heights are sequentially reduced as the measuring point comes downstream, the temperatures of the lower surfaces of the coolant passages 50 can be constantly maintained at 100° C. (=To).

In the above concrete example, the width of the coolant passage 50 is unchanged. However, when the height of the coolant passage 50 is unchanged, the superficial dimensions of the cross-section of the flow path can be gradually decreased by sequentially reducing the width of the coolant passage 50. The above numerical examples are mere examples, and the present invention is not limited thereto as a matter of course.

In this manner, by setting the sectional superficial dimensions of the flow paths of the coolant passages 50 such that the superficial dimensions are sequentially reduced from the coolant inlet 51 to the coolant outlet 53, heat values per unit length of the coolant passages 50 that are to be drawn by the coolant from the objects to be cooled, e.g., the LED modules 44, can be made constant. As a result, it is possible to make uniform the temperatures of the objects to be cooled along the longitudinal direction of the coolant passages 50.

The laser element 68 is described by taking a semiconductor laser using GaAs as an example. However, not limited thereto, another solid laser element such as a YAG laser element or a garnet laser element can be used as a matter of course. Further, a gas laser element can be used. In addition, the LED elements 46 are used as the front-side heating unit 32, which is by way of example. Not limited thereto, SLD (Super Luminescent Diode) elements can be used.

In addition, the semiconductor wafer is taken by way of example as an object to be processed. The semiconductor wafer includes a silicon substrate and a compound semiconductor substrate containing GaAs, SiC or GaN.

Moreover, not limited to these substrates, the present invention can be also applied to a glass substrate used in a liquid crystal display device and a ceramic substrate.

1. An annealing apparatus configured to perform an annealing process to an object to be processed, the annealing apparatus comprising:
a processing vessel in which the object to be processed can be accommodated;
a support unit configured to support the object to be processed in the processing vessel;
a gas supply unit configured to supply a process gas into the processing vessel;
an exhaust unit configured to discharge an atmosphere in the processing vessel; and
a rear-side heating unit including a plurality of laser elements configured to irradiate heating light beams toward an overall rear surface of the object to be processed.

2. The annealing apparatus according to claim 1, wherein
the plurality of laser elements are arranged over a range that is large enough to cover at least the overall rear surface of the object to be processed.

3. The annealing apparatus according to claim 1, wherein
each laser element is formed of a semiconductor laser element, a solid element, or a gas laser element.

4. The annealing apparatus according to claim 1, wherein
the heating light beam irradiated from each laser element has a wavelength band capable of selectively heat a silicon substrate.

5. The annealing apparatus according to claim 1, wherein
one of the support unit and the rear-side heating unit is rotatably supported.

6. The annealing apparatus according to claim 1, further comprising a front-side heating unit arranged opposedly to the rear-side heating unit, the front-side heating unit being configured to irradiate heating light beams toward a front surface of the object to be processed.

7. The annealing apparatus according to claim 6, wherein
the front-side heating unit includes a plurality of LED (Light Emitting Diode) elements or SLD (Super Luminescent Diode) elements which are arranged over a range that is large enough to cover at least the overall front surface of the object to be processed.

8. The annealing apparatus according to claim 6, wherein
at least one of the rear-side heating unit and the front-side heating unit is provided with a cooling mechanism configured to perform a cooling by a coolant.

9. The annealing apparatus according to claim 8, wherein
the cooling mechanism includes a coolant passage through which the coolant flows, and
the coolant passage is set such that superficial dimension of flow path of the coolant passage is sequentially reduced from a coolant inlet toward a coolant outlet.

10. The annealing apparatus according to claim 9, wherein
a width of the coolant passage is constant, and a height of the coolant passage is determined based on a flow rate of the coolant, a specific heat of the coolant, a density of the coolant, and a distance from the coolant inlet.

11. The annealing apparatus according to claim 10, wherein
the height f(x) of the coolant passage is given by the following expression:
f(x)=A²·(To−T(x))²/(Q·cp²·ρ²·(T′(x))²) wherein
A: constant for obtaining heat transfer rate;
Q: flow rate of coolant;
cp: specific heat of coolant;
ρ: density of coolant;
x: distance from coolant inlet;
T(x): coolant temperature at a position of distance x (function)
T′(x): derivative of function T(x); and
To: target temperature.

12. The annealing apparatus according to claim 8, wherein
the cooling mechanism is provided with a plurality of heat pipes for promoting the cooling.

13. The annealing apparatus according to claim 1, wherein
a reflection surface is formed on the rear-side heating unit.

14. The annealing apparatus according to claim 1, wherein
the heating light beam outputted from each laser element has an elliptical irradiation area, and
each laser element is arranged such that a major axial direction of the elliptical irradiation area is oriented along a circumferential direction of the object to be processed.

15. The annealing apparatus according to claim 14, wherein
the plurality of laser elements are concentrically grouped into a plurality of zones, and the laser elements in each group can be controlled for each group.

16. The annealing apparatus according to claim 14, wherein
the plurality of laser elements are mounted on a plurality of laser modules such that each laser module includes a plurality of laser elements to make a unit.

17. The annealing apparatus according to claim 16, wherein
the laser module is formed to have a polygonal shape.

18. The annealing apparatus according to claim 16, wherein
the laser module is detachable and attachable such that a position thereof can be adjusted.
